(19) United States
(12) Patent Application Publication
(10) Pub. No.: US 2007/0249744 A1
(43) Pub. Date: Oct. 25, 2007

(54) Template-Directed Synthesis of Porous Materials Using Dendrimer Precursors

(76) Inventors: Kai Manfred Martin Landskron, Toronto (CA); Benjamin David Hatton, Hamilton, CA (US); Doug Dragan Perovic, Toronto (CA); Geoffrey Alan Ozin, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 10/580,019

(22) PCT Filed: Nov. 19, 2004
(86) PCT No.: PCT/CA04/01990

§ 371 Date: Feb. 27, 2007

Related U.S. Application Data
(60) Provisional application No. 60/523,141, filed on Nov. 19, 2003.
(60) Provisional application No. 60/614,056, filed on Sep. 30, 2004.

(51) Int. Cl. C07F 7/18; C01B 33/16; C08G 77/50

(52) U.S. Cl. 521/142; 521/154; 521/50

(57) ABSTRACT

The present invention provides a template-directed self-assembly strategy to integrate the class of materials called dendrimers with periodic mesoporous and macroporous silica materials to create two totally new classes of organic/inorganic nanocomposite materials, which we call periodic mesoporous dendrisilicas (PMeDs) and periodic macroporous dendrisilicas (PMaDs). The unusual combination of inorganic silica and organic dendrimer chemical structures with these scales of porosity and surfaces suggests a myriad of uses for PMeDs and PMaDs, such as the controlled release and uptake of chemicals, chiral separations and catalysis, electronic printing and microelectronic packaging, biomaterial platforms, chromatography stationary phase, and photonic crystal applications. These applications target the synergistic relationship between the dendrimer and the meso- or macroporous structure within a single hierarchical nanostructured organic/inorganic hybrid material.

### CROSS REFERENCE TO RELATED U.S PATENT APPLICATIONS

This patent application relates to U.S. provisional patent application Ser. No. 60/523,141 filed on Nov. 19, 2003 entitled PERIODIC MESOPOROUS DENDRIMERSILICAS, and U.S. provisional patent application Ser. No. 60/614,056 filed on Sep. 30, 2004 entitled PERIODIC MESOPOROUS DENDRIMERSILICAS AND DENDRIMER INVERTED OPALS, which are both incorporated herein in their entirety by reference.

### FIELD OF THE INVENTION

The present invention relates to new materials, porous polydendrimers, and more particularly the present invention relates to periodic mesoporous polydendrimers and periodic macroporous polydendrimers, based on interconnected dendrimers fashioned into a structure with a periodic arrangement of pores at the mesoporous and macroporous length scales, respectively.

### BACKGROUND OF THE INVENTION

Ordered hierarchical structures comprised of organic and inorganic building blocks self-assembled into architectures with dimensions spanning multiple length scales, akin to those in Nature's biological systems, are beginning to play a key role in the development of nanotechnology, see Hamley, I. W. Nanotechnology with soft materials. Angew. Chem. Int. Ed. 42, 1692-1712 (2003), and Soler-Illia Galo, J de A, Sanchez C, Lebeau B., Patarin J. Chem. Rev. 102, 4093-4138 (2002). In this context, dendrimers are a unique class of nanomaterials having a hyperbranched monodispersed polymer structure and an overall architecture that is well-defined in terms of physical size and shape, internal porosity and surface properties, enabling utility as chemical sensors, drug delivery systems, imaging and contrast agents, see Newkome, G. R., He, E., Moorefield, C. N. Suprasupermolecules with novel properties: Metallodendrimers. Chem. Rev. 99, 1689-1746 (1999), and Fischer, M., Vögtle, F. Dendrimers: Design to Application-A Progress Report. Angew. Chem. Int. Ed. 38, 884-905 (1999).

Materials fashioned into a structure with a periodic arrangement of mesopores, e.g. MCM 41, or macropores represent a special class of compounds that portend applications in catalysis, separation science, chemical sensing and photonics, see Kresge, C. T., Leonowicz, M., Vartuli, J. C., Beck, J. C. Ordered mesoporous molecular sieves synthesized by a liquid-crystal template mechanism. Nature 359, 710-712 (1992); Blanco, Alvaro; Chomski, Emmanuel; Grabtchak, Serguei; Ibisate, Marta; John, Sajeev; Leonardo, Stephen W.; Lopez, Cefe; Meseguer, Francisco; Miguez, Hernan; Mondia, Jessica P.; Ozin, Geoffrey A.; Toader, Ovidiu; Van Driel, Henry M. Large-scale synthesis of a silicon photonic crystal with a complete 3-dimensional bandgap near 1.5 micrometres. Nature (London) (2000), 405(6785), 437-440.

In view of the unique properties of each of these classes of materials, it would be very advantageous to provide a method that allows the integration of these two classes of materials to create a totally new class of nanostructured organic/inorganic hybrid materials. In other words, to combine dendrimer building units with the mesoporous or macroporous structures achieved through templated assembly. The unusual combination of inorganic and organic chemical structure with this scale of porosity and surfaces would permit such new materials to be used in a myriad of different applications, such as the controlled release and uptake of chemicals and drugs, chiral separations and catalysis, electronic printing, microelectronic packaging and photonic applications. These applications target the synergistic relationship between the dendrimer and the meso- or macroporous structure within a single hierarchical, nanostructured organic/inorganic hybrid material.

### SUMMARY OF THE INVENTION

The present invention provides a template directed self-assembly strategy to create nanostructured porous inorganic-organic hybrid materials we call periodic mesoporous dendrisilicas (PMeDs) and periodic macroporous dendrisilicas (PMaDs). The general class of these materials can be called periodic porous polydendrimers (PPPs), of which periodic porous dendrisilicas (PPDs) are a preferred embodiment. The unusual combination of inorganic silica and organic dendrimer chemical structures with these scales of porosity and surfaces suggests a myriad of uses for PMeDs and PMaDs, such as the controlled release and uptake of chemicals, chiral separations and catalysis, electronic printing and microelectronic packaging, biomaterial platforms, chromatography stationary phase, and photonic crystal applications. These applications target the synergistic relationship between the dendrimer and the meso- or macroporous structure within a single hierarchical nanostructured organic/inorganic hybrid material.

The present invention provides a new material comprising a porous polydendrimer with uniform pores of tunable size. The material may be in powder form, formed as a film or fiber, or as a monolith.

The porous polydendrimer may be a periodic mesoporous polydendrimer. It may also be either a macroporous polydendrimer. In a preferred embodiment the polydendrimer is a dendrisilica.

The dendrisilica may be made from any one or combination of dendrimers. In preferred embodiments the dendrisilica is made from Si[(C₂H₄)Si(OEt)₃]₄ (1), or from Si[(C₂H₄)Si(Oi-Pr)₃]₄ (i-Pr=isopropoxy) (2), or from Si[(C₂H₄)Si((C₂H₄)Si(OEt)₃)₃]₄ (3), or from the dendrimer [((EtO)₃Si(C₂H₄))₃]SiCH₂Si[(C₂H₄)Si(OEt₃)]₃ (4), or combinations thereof.

The present invention also provides a method of synthesizing a porous polydendrimer with uniform pores of tunable size, comprising:

mixing a dendrimer with a template under conditions suitable for self-assembly of the dendrimer to form a polydendrimer encapsulating the template; and

removing the template from the polydendrimer to give a porous polydendrimer with uniform pores of tunable size.

The polydendrimer may be made by polymerization of a dendrimer comprising a polymerizable group at an outmost shell of the dendrimer, and wherein the polydendrimer self-assembles upon prior to polymerization of the polymerizable group.

The polydendrimer may be made by polymerization of a mixture of two or more types of dendrimers, each dendrimer of the mixture of two or more dendrimers comprising a polymerizable group at an outmost shell of each dendrimer.

The template may be selected to tune the size of the pores which remain after removal of the template, and may be molecular, ionic, non-ionic, polymers, copolymers, block copolymers, or combinations thereof, to give some non-limiting examples. In addition, the authors anticipate that a combination of mesoscale and macroscale templates may be used in combination or sequentially, to create a mesoporous/macroporous hierarchical porous polydendrimer structure.

The dendrimer may be chosen to give a polydendrimer which is a periodic macroporous dendrisilica. For example, the dendrimer may Si[(C₂H₄)Si(OEt)₃]₄ (1), or it may be Si[(C₂H₄)Si(Oi-Pr)₃]₄ (i-Pr=isopropoxy) (2), or it may be Si[(C₂H₄)Si((C₂H₄)Si(OEt)₃)₃]₄ (3), or it may be [((EtO)₃Si(C₂H₄))₃]SiCH₂Si[(C₂H₄)Si(OEt₃)]₃ (4).

The present invention also provides a method of producing a macroporous polydendrimer inverted opal, comprising the steps of:

infiltrating a dendrimer into void spaces of a colloidal crystal template comprising colloidal particles;

polymerizing the dendrimer to form a polydendrimer; and

removing the colloidal crystal template to give a macroporous polydendrimer with uniform pores of tunable size.

The present invention also provides a method of synthesizing a periodic mesoporous macroporous polydendrimer comprising infiltrating a dendrimer and a mesoscale template into a macroscale colloidal template material under conditions suitable for polymerization of the dendrimer followed by removing both the mesoscale and macroscale template materials from the polydendrimer/template composite to give a periodic mesoporous macroporous polydendrimer (PMeMaP).

### BRIEF DESCRIPTION OF THE DRAWINGS

The method of producing new porous polydendrimers in accordance with the present invention will now be described, by way of example only, reference being made to the accompanying drawings, in which:

FIG. 1a shows self-assembly of 1 with ODTMABR=octadecyltrimethylammoniumbromide, the periodic mesostructured product is illustrated on the right side of the figure and its channel walls consists of a three-dimensional dendrisilica network symbolized by a modified Machatschki symbol of the dendritic repeating unit (in brackets);

FIG. 1b shows a schematic illustration of the self-assembly of a dendrimer with a polymerizable group (in this case: Si(OEt)₃) into a periodic mesoporous dendrisilica (PMeD) whereupon the Si(OEt)₃ groups of the dendrimer hydrolyze and then polymerize around a template, after which the template is removed to give the PMeD;

FIG. 2a) shows powder x-ray diffraction pattern and b) shows TEM images of the powder form of the surfactant-extracted PMeD-1; c) shows a ²⁹Si MAS NMR spectrum and d) shows ¹³C CP MAS NMR spectrum of the surfactant-extracted PMeD-1;

FIG. 3a) shows an SEM image of an as-synthesized PMeD-1 film, b) shows a PXRD spectrum of the same film.

FIG. 4 shows nitrogen adsorption data for the powder form of the surfactant-extracted PMeD, the diagram shows the type IV N₂ isotherm with its BJH analysis of the mesopores (inset);

FIG. 5a) shows a low magnification SEM image of the periodic macroporous dendrisilica (PMaD), and b) shows a corresponding high magnification image; and

FIG. 6 shows PXRD and TEM of the PMeD-2 (FIG. 6a-b) and PMeD-3 (FIG. 6c-d).

### DETAILED DESCRIPTION OF THE INVENTION

As used herein, the term “dendrimer” means a hyperbranched monodispersed molecule or macromolecule.

As used herein, the term “template” means ionic and non-ionic molecules or polymers or monodispersed colloidal particles that have a structure directing function for another molecule or polymer.

As used herein, the term “molecular template” means ionic and non-ionic molecules or polymers that have a structure directing function for another molecule or polymer.

As used herein, the term “colloidal crystal template” means a template consisting of monodispersed colloidal particles that exceed about 50 nm in diameter.

As used herein, the term “periodic mesoporous” means having an ordered arrangement of pores in terms of translational symmetry with a pore diameter between about 2 and about 50 nm.

As used herein, the term “periodic macroporous” means having an ordered arrangement of pores in terms of translational symmetry with a pore diameter greater than 50 nm.

As used herein, the term “polydendrimer” means a polymeric material that is composed of dendrimers that are connected by covalent bonds.

As used herein, the term “dendrisilica” means a polymer that contains building units of dendrimers linked by Si—O—Si bridges at the outmost shell of the dendrimer.

As used herein the term “dendrimer inverted opal” means dendrimers fashioned into a structure with periodic macropores.

As used herein, the term “surfactant mesostructure” means an ordered supramolecular assembly of surfactant molecule micelles, with a translational symmetry between about 2 and about 50 nm.

As used herein, the term “tunable” means being capable of being defined or pre-selected through choice of template.

The present invention describes new nanostructured organic/inorganic hybrid materials, referred to as porous polydendrimers with pores of pre-selected, tunable size which may or may not be periodic. The porous polydendrimers may be mesoporous polydendrimers or macroporous polydendrimers.

More particularly, the present invention describes new nanostructured organic/inorganic hybrid materials, referred to as periodic mesoporous dendrisilica (PMeD) and periodic macroporous dendrisilica (PMaD), based on dendrimers fashioned into a structure with a periodic arrangement of mesopores or macropores, thereby integrating the classes dendrimers and periodic meso- and macroporous materials. These materials are the preferred embodiment of a general class of periodic mesoporous and macroporous polydendrimers, or periodic porous polydendrimers (PPPs). The size, the uniformity and the periodicity of the pores can be tuned by the choice of template in the directed self-assembly process.

The present invention describes a method to polymerize a dendrimer carrying polymerizable groups at the outermost shell in the presence of a template to give an ordered nanocomposite comprised of the template and the polydendrimer. The method of synthesizing a periodic mesoporous polydendrimer includes mixing a dendrimer with a molecular template material under conditions suitable for self-assembly and polymerization of the dendrimer followed by removing the template material from the self-assembled polydendrimer to give a periodic mesoporous polydendrimer (PMeP).

The method of synthesizing a periodic macroporous polydendrimer includes infiltrating a dendrimer into a colloidal template material under conditions suitable for polymerization of the dendrimer followed by removing the template material from the polydendrimer/template composite to give a periodic macroporous polydendrimer (PMaP).

In a preferred embodiment the present invention describes new nanostructured organic/inorganic hybrid materials, referred to as periodic mesoporous dendrisilicas (PMeDs) and periodic macroporous dendrisilicas (PMaDs), based on dendrimers fashioned into a structure with a periodic arrangement of mesopores or macropores, thereby integrating dendrimers with periodic meso- and macroporous structure.

The present invention describes a method to polymerize a dendrimer carrying alkoxysilane groups at the outermost shell in the presence of a template to give an ordered nanocomposite comprised of the template and the dendrisilica.

The invention also describes template removal to maintain the periodic meso- or macrostructure comprised of dendrimer building blocks. Template removal can be achieved by methods such as thermal decomposition, thermolysis, solvent extraction, supercritical fluid extraction, photolytic decomposition, and plasma etching.

The present invention will be exemplified using known dendrimers (1) and (2) and novel dendrimers tetrakis[2-(tris-(triethoxy, 2-ethylsilyl)silyl)ethyl]silane having a formula Si[(C₂H₄)Si((C₂H₄)Si(OEt)₃)₃]₄ (3) and bis-[tris-(2-(triethoxysilyl)ethyl)disila]methane having a formula [((EtO)₃Si(C₂H₄))₃]SiCH₂Si[(C₂H₄)Si(OEt₃)]₃ (4) discussed hereinafter which all use tri-ethoxysilyl groups, however the present invention is not restricted to these as other polymerizable groups may be used in the outermost shell besides those containing silicon.

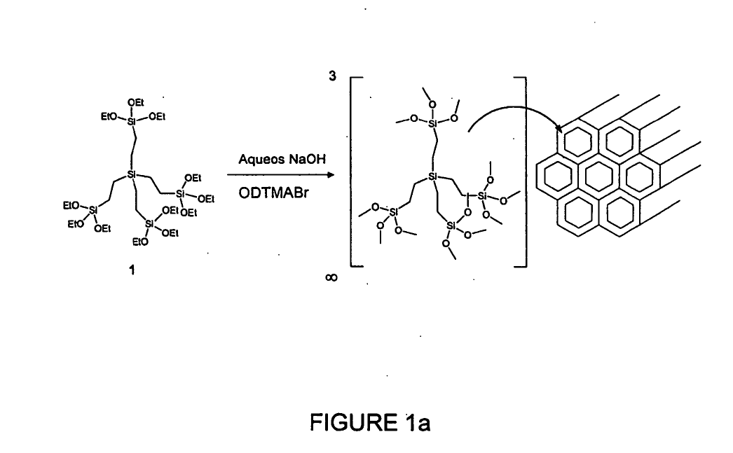

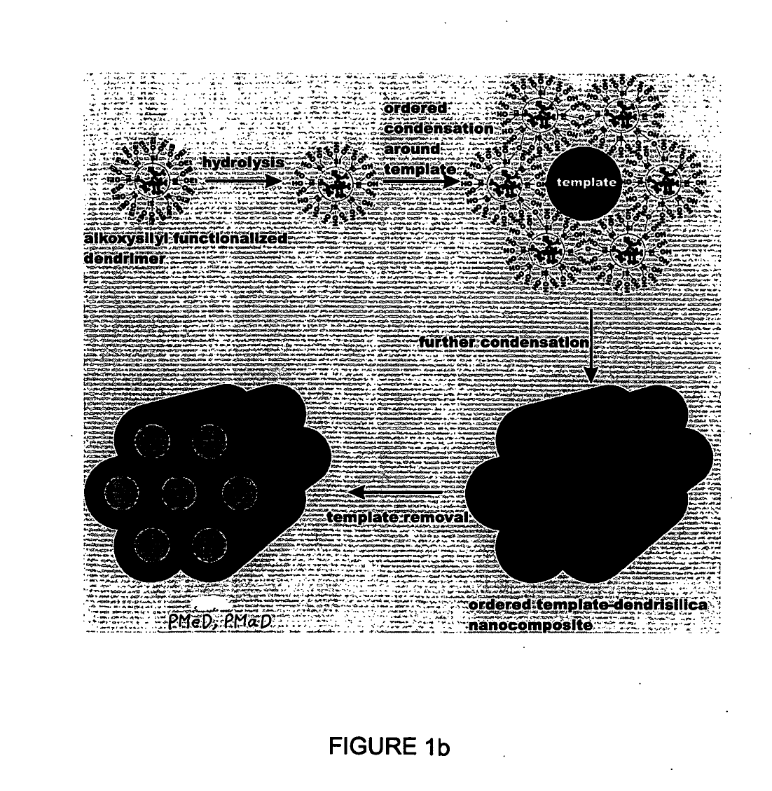

The silsesquioxane Si[(C₂H₄)Si(OEt)₃]₄ (1) (FIG. 1) was chosen as the precursor for PMeDs and PMaDs in the studies disclosed herein. It can be seen as the first generation of a dendrimer with the central Si atom as the core and the Si(OEt)₃ groups as the shell bridged to the core by C₂H₄ arms. It can be synthesized from tetravinylsilane and trichlorosilane in THF with dihydrogenhexachloroplatinate as catalyst to give Si[(C₂H₄)SiCl₃]₄, which can then be converted into compound 1 utilizing ethanol, see Michalczyk, M. J., Simonsick, , W. J. Jr., Sharp, K. G. Characterization of polyfunctional alkoxysilanes using potassium (K+) ionization of desorbed species mass spectrometry. J. Organomet. Chem. 521, 261-266 (1996).

The inventors have demonstrated that compound 1 can be co-assembled with a surfactant mesophase in an aqueous solution to create the first periodic mesoporous dendrisilica (PMeD-1). Both powder and oriented film morphologies have been made (using compound 2), and cast monoliths can be expected to form by the application of similar procedures. Also, it has been demonstrated that compound 1 can be infiltrated into a latex colloidal crystal template to create the first periodic macroporous dendrisilica (PMaD). Moreover, the inventors have also shown that the respective second generation dendrimer Si[(C₂H₄)Si((C₂H₄)Si(OEt)₃)₃]₄ (3) and a first generation dendrimer with a modified core [((EtO)₃Si(C₂H₄))₃]SiCH₂Si[(C₂H₄)Si(OEt₃)]₃ (4) can be self-assembled in a similar way to give PMeD-2 and PMeD-3.

The invention will now be described using the following non-limiting examples of dendrimers, namely compounds Si[(C₂H₄)Si(OEt)₃]₄ (1), FIG. 1, and (2) Si[(C₂H₄)Si(Oi-Pr)₃]₄ (i-Pr=isopropoxy) templated using a non-limiting example of a template, namely octadecyltrimethylammoniumbromide (ODTMABR), into a periodic mesoporous dendrisilica structure. Moreover the dendrimers 3 and 4 will be self-assembled into PMeD-2 and PMeD-3 using the non-ionic surfactant Pluronic 123™.

### EXAMPLE 1

Synthesis of 1 and 2

The synthesis of compound 1 was performed according to literature as disclosed in Michalczyk, M. J., Simonsick, , W. J. Jr., Sharp, K. G. Characterization of polyfunctional alkoxysilanes using potassium (K⁺) ionization of desorbed species mass spectrometry. J. Organomet. Chem. 521, 261-266 (1996).

Compound 2 was prepared analogously, however isopropanol was used instead of ethanol.

Synthesis of Periodic Mesoporous Dendrisilica (PMeD-1)

Referring to FIGS. 1a and 1b, Octadecyltrimethylammoniumbromide (ODTMABR) (0.72 mmol, 270 mg, Aldrich) was dissolved in a solution of dry NaOH (3 mmol, 240 mg) and 24 g de-ionized water at 20° C. Compound 1 (2.4 mmol, 1.9 g) was added to this solution, which was stirred for 1 d at 20° C. while a white precipitate formed which is the polymerized dendrimer/template composite. Afterwards the precipitate was aged 2 d at 80° C. which improves the periodicity of the composite. Then the precipitate was filtered off and washed with copious amounts of water. The as-synthesized sample was then stirred for 12 h in a solution of 12 g HCl (36 wt %) and 80 g of methanol to remove the OCTMABR template. The sample was then filtered off again and washed with copious amounts of MeOH, to give the surfactant extracted PMeD as a powder. In FIG. 1a, the final structure is shown at the right hand side which shows a hexagonally ordered PMeD with a one-dimensional pore system and the interconnected dendrimer building blocks composing the pore walls. The three-dimensional dendrisilica network is symbolized by a modified Machatschki symbol of the dendritic repeating unit (in brackets) with the numeral 3 indicating a 3-dimensional structure and the fact that it is a polymer is indicated by the infinity symbol.

With particular reference to FIG. 1b, there is shown a schematic illustration of the above described self-assembly of a dendrimer with a polymerizable group (in this case: Si(OEt)₃) into a periodic mesoporous dendrisilica (PMeD). The Si(OEt)₃ groups of the dendrimer hydrolyze and then polymerize around a template. After the template removal the PMeD is obtained.

Alternatively, instead of a powder, monoliths are made by sol-gel methods known to those skilled in the art. The dendrimers are mixed with a template in an aqueous solution to give a homogeneous sol. After gelation of the sol in the reaction vessel the PMeD is obtained as a monolith, and the template can be extracted with organic or inorganic solvents. The shape of the reaction container can be used to define the shape of the monolith, see Attard, G. S., Glyde, J. C., & Goltner, C. G. (1995). Liquid-crystalline phases as templates for the synthesis of mesoporous silica. Nature, 378(6555), 366-368.

Films are made by spin-coating, dip-coating or casting a synthesis solution. A typical synthesis involves mixing 0.7125 g of 10⁻³M HCl, 2.2517 g EtOH, and 0.900 g aqueous cetyltrimethylammonium chloride solution (25 wt. %, Aldrich) to make a homogeneous solution, then adding 1.0457 g of compound 2 and stirring vigorously for 30 minutes (final molar ratio 1.0:70.8:6.54×10⁻⁴:45.3:0.65 of 2:H₂O:HCl:EtOH:cetyltrimethylammonium chloride). After spin-coating at rates of 1200-3600 rpm onto glass or a Si (100) wafer the films were dried in air at room temperature for 24 h and washed in DI H₂O before calcination at 300° C. under flowing nitrogen for 5 h, heating at 1° C./min. The authors believe that a vapour deposition method may be applied alternatively.

Alternatively fibers are made by extruding or spinning a viscous sol containing the dendrimers, the template and the solvent to produce a polydendrimer/template nanocomposite fiber. The template is removed from the fibers by known solvent extraction methods to leave a mesoporous polydendrimer, see Bruinsma, P. J., Kim, A. Y., Liu, J., & Baskaran, S. (1997). Mesoporous Silica Synthesized by Solvent Evaporation: Spun Fibers and Spray-Dried Hollow Spheres. Chem. Mater., 9, 2507-2512.

Characterization of Periodic Mesoporous Dendrisilica (PMeD-1)

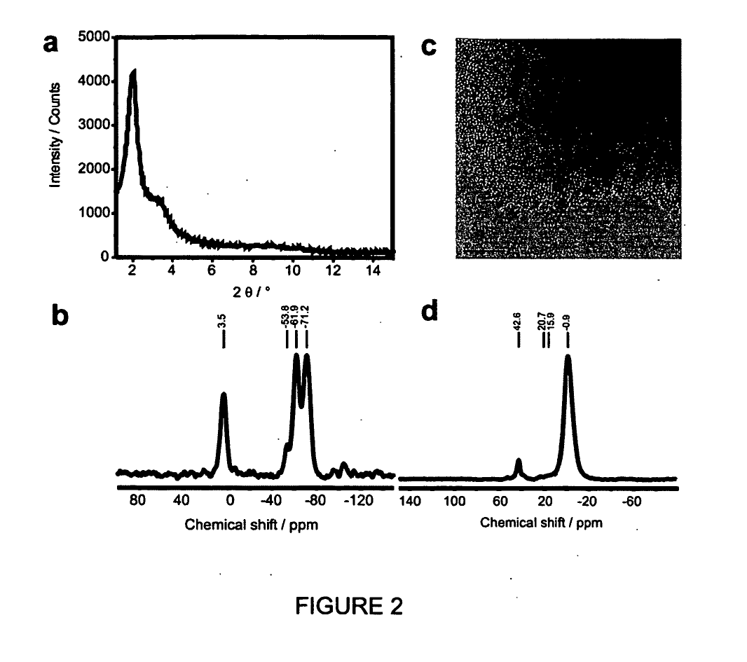

FIG. 2a shows the powder x-ray pattern of the surfactant-extracted PMeD-1. The 100 reflection gives a d-spacing of 4.0 nm. Transmission electron microscopy (TEM) images of the PMeD provided additional structural information, showing the presence of periodic arrays of parallel-aligned mesoscale channels with a spacing of 3.9 nm, mesopores of about 2.5 nm and a wall thickness of 2.3 nm (FIG. 2b).

The magic angle spinning nuclear magnetic resonance (MAS NMR) spectroscopy of the PMeD showed that no significant Si—C bond cleavage occurred during the synthesis. To expand on this key point, the surfactant-extracted material (FIG. 2c) shows four peaks at 3.5, 53.8, 61.9 and 71.2 ppm similar to the chemical shifts for the ²⁹Si MAS NMR signals of the precursor 1. The signal at 3.5 ppm can be assigned to the SiC₄ building units of the dendrimer core, while the other signals represent T₁ SiC(OSi)(OH)₂ (53.8 ppm), T₂ SiC(OSi)₂(OH) (61.9 ppm) and T₃ SiC(OSi)₃ (71.2 ppm) tetrahedral units. The cross polarization (CP) MAS NMR spectroscopy of the PMeD indicates that full removal of the surfactant had occurred by showing a peak at −0.9 ppm, typical for a CH₂CH₂ bridge between two Si atoms.⁷ A small signal at 42.8 ppm indicates some methoxylation of the silanol groups during the extraction process. By comparison all periodic mesoporous organosilicas (PMOs) to date only show T SiO₃C⁸or D SiO₂C₂⁹ building blocks in their MAS NMR spectra, while the SiC₄ units in PMeDs are unprecedented.

Thermogravimetry analysis of the extracted PMeD-1 performed in air or N₂ revealed no significant mass loss up to 250° C. except the loss of some physisorbed water between 20 and 100° C. The mesostructure of the PMeD remains with no significant pore shrinkage or decrease of order up to 400° C. Above 400° C. pore shrinking and gradual loss of order occurs, however the mesostructure can be seen still clearly at 900° C. ²⁹Si MAS NMR spectroscopy of thermally treated samples under N₂ showed only signals at 3.8 ppm for the SiC₄ unit and between −45 and −75 ppm for the SiO₃C units up to 400° C. From 500° C. the signals for the SiC₄ units disappear almost completely while signals for Q sites (SiO₄) appear around −110 ppm.

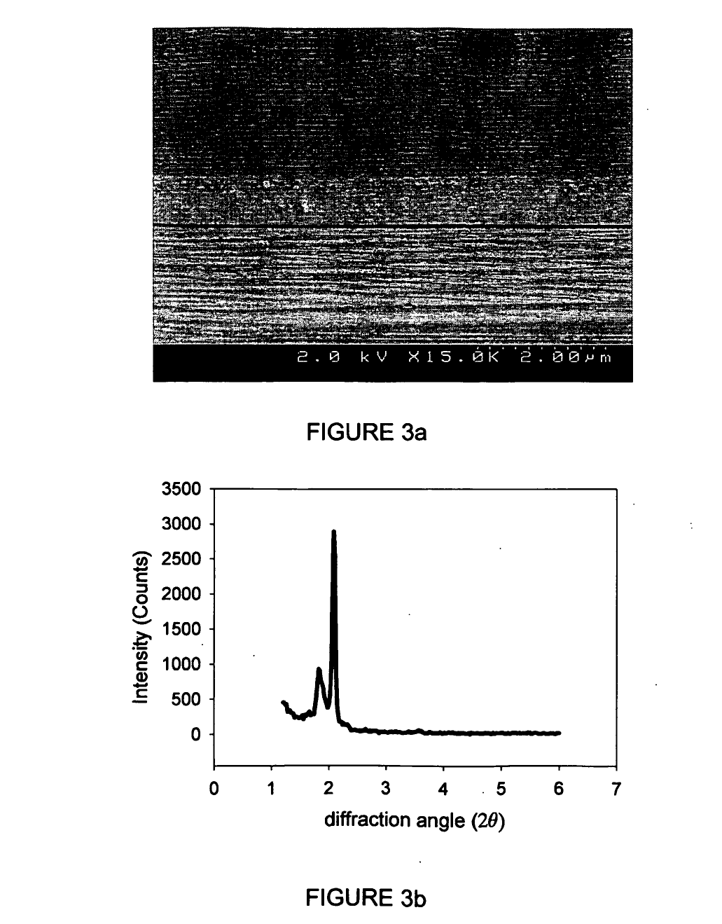

The PMeD-1 was also obtained as a supported oriented film by spin coating onto a glass slide a mixture of Si[(C₂H₄)Si(Oi-Pr)₃]₄ (2), HCl (10-3 M), cetyltrimethylammoniumchloride (CTMACl) and ethanol, which had been stirred for 20 minutes at room temperature. These films have been characterized by scanning electron microscopy SEM and powder x-ray diffraction PXRD (FIG. 3a-b). In order to ensure the organic groups remained intact inside the channel walls after spin coating, 50 thin film samples were prepared on glass substrates (with area 2×2 cm). The films were scratched off the substrate and powdered to give a 25 mg sample, which was then investigated by ²⁹Si MAS NMR. These samples showed only the signal for SiC₄ and SiO₃C units, thereby confirming the Si—C bonds were not cleaved in the self-assembly synthesis and film forming process.

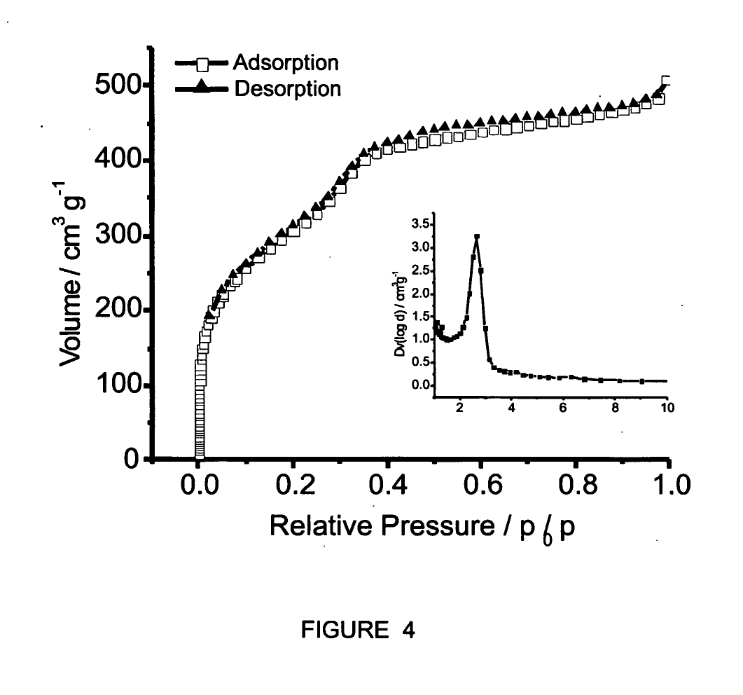

Nitrogen adsorption data for the powder form of the PMeD-1 shows a diagnostic type IV isotherm with well-defined capillary condensation and very little hysteresis (FIG. 4). The Brunauer Emmett Teller (BET) surface area is found to be as high as 1102 m2/g and the mesopore diameter is about 2.5 nm, calculated by BJH methods (FIG. 4) close to that seen in TEM images (FIG. 2b). This adsorption data together with the d spacing of 4.0 nm given by PXRD provides an independent estimate of the channel wall thickness of about 1.5 nm thereby corroborating the diameter of the mesopores and thickness of the channel walls obtained by TEM imaging. Density functional theory (DFT) analysis of the low pressure arm of the isotherm also suggests the presence of micropores with diameters in the range of 1.0-1.5 nm, however further work is necessary to confirm this unambiguously.

### EXAMPLE 2

Synthesis of Periodic Macroporous Dendrisilica (PMaD)

An ordered colloidal crystal of polystyrene (PS) latex colloidal crystals of diameter ca. 200 nm was prepared by sedimentation from a stabilized suspension. A solution of 0.908 g of 1 was stirred into a homogeneous mixed solution of with 0.361 g of HCl (10⁻³ M) and 0.560 g EtOH until homogeneous due to the hydrolysis of the ethoxy groups of the dendrimer, and was then dropped onto the latex colloidal crystal and allowed to infiltrate the colloidal crystal in order to polymerize the dendrimer building blocks around the particles of the colloidal crystal template. The infiltrated colloidal crystal was dried at 60° C., before heating to 400° C. in air for 5 hours (heating at 1° C./min) to burn away the polymer template. The colloidal crystal may be a photonic colloidal crystal characterized by intense Bragg diffraction so that the resulting structures after inversion is also a photonic crystal.

PMaD structures may be made using compounds (2), (3) and (4) disclosed herein in addition to any other dendrimer compound. The periodic macroporous dendrisilica may be useful as photonic crystals in various optical applications, or in catalytic or biomedical applications.

Characterization of Periodic Macroporous Dendrisilica (PMaD)

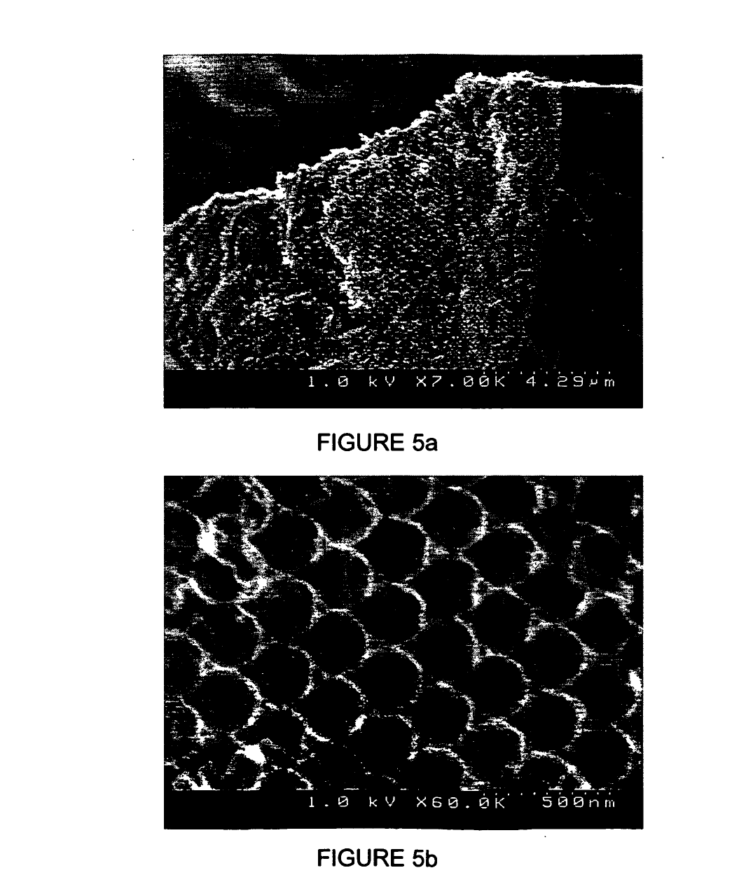

The PMaD was characterized by scanning electron microscopy (SEM). The SEM images (FIGS. 5a and b) clearly show the periodic macroporous structure of the PMaD, with pores of diameter ca. 200 nm.

### EXAMPLE 3

Synthesis of tetrakis[2-(trivinylsilyl)ethyl]silane

1.02 g (1.5 mmol) tetrakis[2-(trichlorosilyl)ethyl]silane were dissolved in 50 ml THF dried over Na/benzophenone. This solution was added dropwise to 27 ml of a 1 N solution of vinylmagnesiumbromide in THF (Aldrich) at room temperature within 1 h. The mixture was stirred for 24 h at room temperature and then added to 200 ml of an aqueous 1 N ammonium chloride solution mixed with ice. This mixture was shaken for 2 min until ethene evolution ceased. 200 ml of hexane were added and the mixture was transferred to a separation funnel. Then the mixture was shaken vigorously for another minute and after phase separation was completed the organic layer was separated from the aqueous layer. After removal of the hexane, a yellow oil was obtained. This raw product was further purified by column chromatography using hexamethyldisilazane treated silica gel giving pure tetrakis[2-(trivinylsilyl)ethyl]silane in a yield of 70%. ¹³C (300 MHz, CDCl₃): δ 134.65 (s, CH₂), 134.51 (s, CH), 4.85 (s, CH₂), 2.61 (CH₂). ¹H (300 MHz, CDCl₃): δ 6.1-6.3 (24 H, m), 5.7-5.9 (12 H, m), 0.54-0.65 (16 H, m).

Synthesis of tetrakis[2-(tris-(triethoxy, 2-ethylsilyl)silyl)ethyl]silane (3)

0.57 g (1 mmol) tetrakis[2-(trivinylsilyl)ethyl]silane, 4.7 g (18.8 mmol) trichlorosilane (Aldrich) and 3.1 ml dry THF are mixed under N₂ atmosphere. To this solution 0.1 mg dihydrogenhexachloroplatinate dissolved in 0.1 ml absolute ethanol was added. The mixture was stirred for 5 h at room temperature under N₂ atmosphere. To this solution 250 ml dry heptane (Aldrich) were added. Then the excess trichlorosilane and the THF was evaporated in vacuum to give a heptane solution of tetrakis[2-(tris-(trichloro, 2-ethylsilyl)silyl)ethyl]silane. To this heavily stirred solution a solution of 4.9 g (36 mmol) absolute ethanol in 250 ml heptane was added dropwise within 10 h via a dropping funnel at a pressure of 200 Torr and room temperature. The solution was stirred for another 12 h at room temperature, then the heptane and the excess of ethanol was evaporated in vacuum to give 2 in 95% yield. ¹³C (300 MHz, CDCl₃): δ 58.24 (s, CH₂), 18.33 (s, CH₃), 3.12 (CH₂), 2.76 (CH₂), 2.48 (s, CH₂), 1.75 (CH₂),. ¹H (300 MHz, CDCl₃): δ 3.80 (72 H, q), 1.22 (108 H, t), 0.2-0.65 (64 H, m). MS (ES) (m/z)=2571 (m+23, 100%).

Synthesis of PMeD-2

NaCl (31.7 mmol, 1.85 g) and 0.336 g Pluronic 123 (BASF) were dissolved in 2 N HCl (8.4 g) and H₂O (155 mmol, 2.8 g). To this solution bis-[tris-(2-(triethoxysilyl)ethyl)disila]methane (3) (0.25 mmol, 0.94 g) was added under vigorous stirring at room temperature. The mixture was stirred at room temperature for 24 h while a white precipitate formed and kept under static conditions for another 48 h at 80° C. After filtration the PMeD was obtained as a white powder. The extraction to remove the Pluronic 123 template was carried out by stirring the as-synthesized PMeDs in a mixture of 250 ml acetone and 10 ml 2N HCl for 4 d at 50° C. After the extraction the product was filtered off and washed with acetone and the final product is a powder.

### EXAMPLE 4

Synthesis of bis-(trivinyidisila)methane

1 g (2.9 mmol) bis-(triethoxy)disilamethane (Gelest) were dissolved in 50 ml THF dried over Na/benzophenone. This solution was added dropwise to 27 ml of a 1 N solution of vinylmagnesiumbromide in THF (Aldrich) at room temperature within 1 h. The mixture was stirred for 24 h at room temperature and then added to 200 ml of an aqueous 1 N ammonium chloride solution mixed with ice. This mixture was shaken for 2 min until ethene evolution ceased. 200 ml hexane were added and the mixture was transferred to a separation funnel. Then the mixture was shaken vigorously for another minute and after phase separation was completed the organic layer was separated from the aqueous layer. After removal of the hexane a yellow oil was obtained. This raw product was further purified by column chromatography using hexamethyldisilazane treated silica gel giving pure tetrakis[2-(trivinylsilyl)ethyl]silane in a yield of 70%. ¹³C (300 MHz, CDCl₃): δ 136.40 (s, CH₂), 133.94 (s, CH), −4.25 (CH₂). ¹H (300 MHz, CDCl₃): δ 6.0-6.4 (12H, m), 5.7-5.9 (6 H, m), 0.21 (2 H, m).

Synthesis of bis-[tris-(2-(triethoxysilyl)ethyl)disila]methane (4)

1.25 g (5.3 mmol) bis-(trivinyidisila)methane, 6.4 g (47.7 mmol) trichlorosilane (Aldrich) and 5.2 ml dry THF are mixed under N₂ atmosphere. To this solution 0.1 mg dihydrogenhexachloroplatinate dissolved in 0.1 ml absolute ethanol was added. The mixture was stirred for 5 h at room temperature under N₂ atmosphere. To this solution 250 ml dry heptane (Aldrich) were added. Then the excess trichlorosilane and the THF was evaporated in vacuum to give a heptane solution of bis-[tris-(2-(trichlorosilyl)ethyl)disila]methane. To this heavily stirred solution a solution of 13.1 g (286 mmol) absolute ethanol in 250 ml heptane was added dropwise within 10 h via a dropping funnel at a pressure of 200 Torr and room temperature. The solution was stirred for another 12 h at room temperature, then the heptane and the excess of ethanol was evaporated in vacuum to give bis-[tris-(2-(triethoxysilyl)ethyl)disila]methane in 95% yield. ¹³C (300 MHz, CDCl₃): δ 58.31 (s, CH₂), 18.25 (s, CH₃), 3.25 (s, CH₂), 2.25 (CH₂). ¹H (300 MHz, CDCl₃): δ 3.80 (36H, q), 1.20 (54 H, t), 0.40-0.65 (24 H, m), −0.33 (2 H, s). MS (ES) (m/z)=1239 (m+23, 100%).

Synthesis of PMeD-3

NaCl (31.7 mmol, 1.85 g) and 0.336 g Pluronic 123 (BASF) were dissolved in 2 N HCl (8.4 g) and H₂O (155 mmol, 2.8 g). To this solution bis-[tris-(2-triethoxysilyl)ethyl)disila]methane (4) (0.66 mmol, 0.94 g) was added under vigorous stirring at room temperature. The mixture was stirred at room temperature for 24 h while a white precipitate formed and kept under static conditions for another 48 h at 80° C. After filtration the PMeD was obtained as a white powder. The extraction of the Pluronic 123 template was carried out by stirring the as-synthesized PMeDs in a mixture of 250 ml acetone and 10 ml 2N HCl for 4 d at 50° C. After the extraction the product was filtered off and washed with acetone again to give a powder product.

Characterization of PMeD-2 and PMeD-3

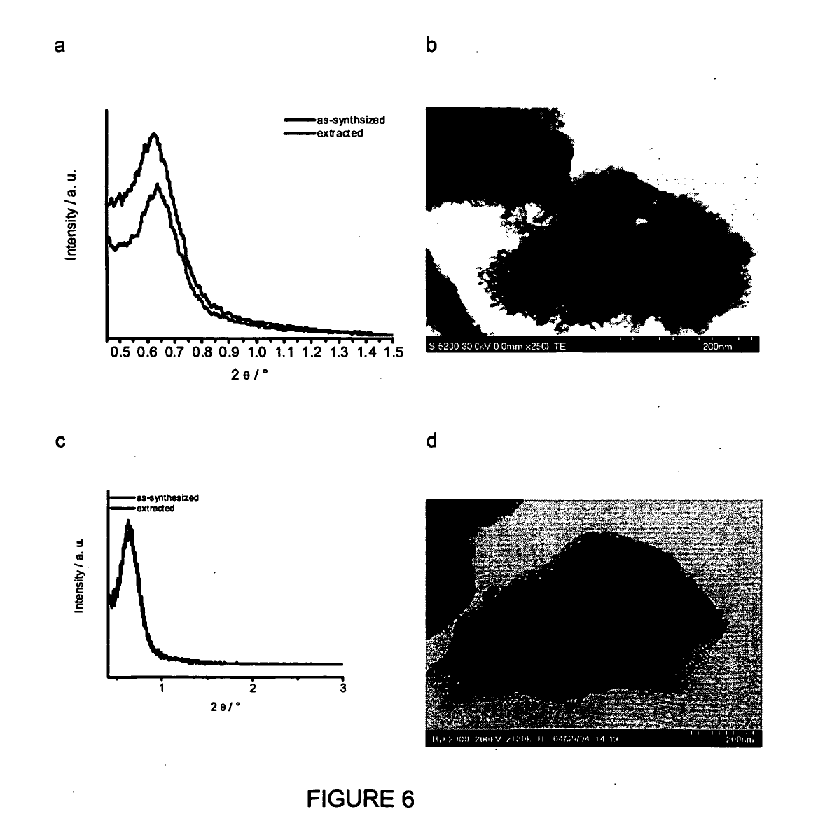

The PXRD and the TEM of the PMeD-2 and PMeD-3 (FIG. 6) show that also these materials can be reproducibly made with a high degree of mesostructural order with the PXRD providing a d-spacing of 14.4 nm (PMeD-2) and 14.1 nm (PMeD-3). Furthermore TEM suggests pore sizes of about 8 nm and a pore wall thickness of ca. 6 nm. ²⁹Si MAS NMR investigations showed two signals for the SiC₄ (11 ppm) and SiO₃C (59 ppm) building units for PMeD-2 (10 and 58 ppm for PMeD-3). The integration of the signals revealed a molar ratio of 1:3.1, which is slightly higher then the theoretical value of 1:2.4, indicating that some of the SiC₄ units have transformed into SiO₃C units, most likely originating from some minor Si—C bond cleavage. However, the NMR data suggests that the majority of the dendrimer building units keep intact during self-assembly. Similar the integrals for PMeD-3 showed a ratio of 1:4.1 instead of 1:3. It is noteworthy that no SiO₄ units are observed in the material. The integral ratios were reproducible with varying pulse delay times between 3 and 30 s indicating that the ²⁹Si nuclei are sufficiently relaxed to give accurate integrals. Nitrogen isotherms demonstrated the ordered mesoporous nature of both PMeD-2 and PMeD-3 by showing typical type IV isotherms. The Brunauer-Emmett-Teller surface area was found to be 775 (PMeD-2) and 767 m²g⁻¹ (PMeD-3). The BJH analysis revealed a narrow pore size distribution with average pore sizes of 9.1 (PMeD-2) and 8.2 nm (PMeD-3), which is consistent with the TEM data.

Instrumentation

PXRD patterns were measured with a Siemens D5000 diffractometer using Cu Kα₁-radiation (λ=154.18 pm). TEM images were recorded on a Philips 430 microscope at an accelerating voltage of 200 kV (film fragments on C film-coated Cu grids). All solid state NMR experiments were performed with a Bruker DSX 400 NMR spectrometer. ²⁹Si MAS-NMR spectra were recorded at a spin rate of 5 kHz and a pulse delay of 5 s. ¹³C CP MAS-NMR experiments were performed at a spin rate of 5 kHz, a contact time of 5 ms and a pulse delay of 3 s. TGA experiments were carried out with a Perkin-Elmer TGA7 instrument with a heating rate of 1° C. Sorption experiments were performed by a Quantachrome Autosorb-1C machine with N₂ as sorption gas at 77 K starting at a relative pressure p/p0=10-5. 7 data points were selected for BET analysis from relative pressure of 0.1. SEM images were recorded with a Hitachi S-4500 microscope at 1 kV (no Au coating).

With the work presented herein the inventors have demonstrated for the first time that a dendrimer shaped molecule can be fashioned into a periodic meso- or macroporous structure to create a new class of nanostructured organic/inorganic hybrid that we call periodic mesoporous dendrisilicas (PMeDs) and periodic macroporous dendrisilicas (PMaDs). The general class of these materials are referred to herein as porous polydendrimers, of which periodic porous polydendrimers (PPPs) are preferred, and more preferred are porous dendrisilicas (PPDs). The inventors contemplate that other organic, inorganic or organic-inorganic dendrimers with different cores, arms and generations can also be self-assembled by similar structure-directed template-based synthetic methods to form new families of PMeDs and PMaDs in which the properties of dendrimers are synergetically combined with those of periodic meso- and macroporous materials. Various other templates such as different ionic surfactants, block copolymers or colloidal crystals of other length scales can be expected to be useful templates to tailor the pore size. Because the template defines the size and uniformity of the pores, the pore size is said to be tunable. The template also defines the periodic structural phase (ie; 2D hexagonal, FCC), but also can include non-periodic structures having uniform pore size distribution (ie; worm-like mesoporous structures). The variety of choice for the dendrimer and template makes these materials important and useful for a broad range of applications. Non-limiting examples of applications are low-k materials for microelectronics, separation technologies, e.g. chiral drug separations or waste water cleaning, catalysis, drug delivery, chemical storage, e.g. gas storage, and sensors including biosensors. The use of larger scale colloidal crystal templates makes these dendritic macroporous materials suitable for photonic applications or as a scaffold for biomedical tissue growth, in combination with the applications mentioned above.

It will be appreciated that compounds 1, 2, 3 and 4 are non-limiting examples only and that the core may be one of numerous elements or organic or inorganic groups not restricted to silicon, the number of shells may be varied and may involve combinations of organic/inorganic, pure organic etc. The dendrimer has to carry a polymerizable group at the outmost shell which in the present example is achieved using tri-alkoxysilyl groups in the outmost shell. However, it will be appreciated by those skilled in the art that other polymerizable groups may be used which are not restricted to tri-alkoxysilyl groups. For example, vinyl groups or trichloro-silyl groups may be used, just to give non-limiting examples.

It will be appreciated that different template materials may be used, with the choice of template material being selected to give for example selective control of pore size in the mesoporous or macroporous structure. While surfactants in general may be used, it will be understood that colloidal crystal templates may be used, or combinations thereof. It will also be appreciated that a periodic mesoporous macroporous polydendrimer (PMeMaP) may be synthesized by infiltrating a dendrimer and a mesoscale template into a macroscale colloidal template material under conditions suitable for polymerization of the dendrimer followed by removing both the mesoscale and macroscale template materials from the polydendrimer/template composite.

The properties of the resulting mesoporous or macroporous polydendrimer depend on the nature of the core, the arms and the number of generations, template and structure type, e.g. MCM41, MCM48 etc. Basic areas of application are microelectronics (low k materials), separation techniques (e.g. chiral drug separation), bio-delivery, chemical storage (e.g. gas storage), catalysis.

Post-synthesis steps may include adding various reactive groups on the dendritic building block, the use of the porous polydendrimer as a template and inversion of the porous polydendrimer.

As used herein, the terms “comprises” and “comprising” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

1. Hamley, I. W. Nanotechnology with soft materials. Angew. Chem. Int. Ed. 42, 1692-1712 (2003).
2. Soler-Illia Galo, J de A A, Sanchez C, Lebeau B., Patarin J. Chem. Rev. 102, 4093-4138 (2002).
3. Newkome, G. R., He, E., Moorefield, C. N. Suprasupermolecules with novel properties: Metallodendrimers. Chem. Rev. 99, 1689-1746 (1999).
4. Fischer, M., Vögtle, F. Dendrimers: Design to Application-A Progress Report. Angew. Chem. Int. Ed. 38, 884-905 (1999).
5. Kresge, C. T., Leonowicz, M., Vartuli, J. C., Beck, J. C. Ordered mesoporous molecular sieves synthesized by a liquid-crystal template mechanism. Nature 359, 710-712 (1992).
6. Michalczyk, M. J., Simonsick, , W. J. Jr., Sharp, K. G. Characterization of polyfunctional alkoxysilanes using potassium (K+) ionization of desorbed species mass spectrometry. J. Organomet. Chem. 521, 261-266 (1996).
7. Inagaki, S., Guan, S., Fukushima, Y., Ohsuna, T., Terasaki, O. Novel Mesoporous Materials with a Uniform Distribution of Organic Groups and Inorganic Oxide in Their Frameworks. J. Am. Chem. Soc. 121, 9611 (1999).
8. Asefa, T., Ozin, G. A., Grondey H., Kruk, M., Jaroniec, M. Recent developments in the synthesis and chemistry of periodic mesoporous organosilicas. Stud. Surf. Sci. Catal. 141, 1 (2002).
9. Landskron, K., Hatton, B. D., Perovic, D. D., Ozin, G. A. Periodic mesoporous organosilicas containing interconnected [Si(CH2)]3 rings. Science 302, 266 (2003).
10. Bruinsma, P. J., Kim, A. Y., Liu, J., & Baskaran, S. Mesoporous Silica Synthesized by Solvent Evaporation: Spun Fibers and Spray-Dried Hollow Spheres. Chem. Mater., 9, 2507-2512 (1997).
11. Attard, G. S., Glyde, J. C., & Goltner, C. G. Liquid-crystalline phases as templates for the synthesis of mesoporous silica. Nature, 378(6555), 366-368 (1995).

1. A material comprising a periodic porous polydendrimer with uniform pores of tunable size.

2. The material according to claim 1 wherein the periodic porous polydendrimer is a periodic mesoporous polydendrimer.

3. The material according to claim 1 wherein the periodic porous polydendrimer is a periodic macroporous polydendrimer.

4. The material according to claim 2 wherein the periodic mesoporous polydendrimer is periodic mesoporous dendrisilica.

5. The material according to claim 3 wherein the periodic macroporous polydendrimer is periodic macroporous dendrisilica.

6. The material according to claim 4 wherein the dendrisilica is made from dendrimer Si[(C₂H₄)Si(OEt)₃]₄ (1).

7. The material according to claim 4 wherein the dendrisilica is made from Si[(C₂H₄)Si(Oi-Pr)₃]₄ (i-Pr=isopropoxy) (2).

8. The material according to claim 4 wherein the dendrisilica is made from dendrimer Si[(C₂H₄)Si((C₂H₄)Si(OEt)₃)₃]₄ (3).

9. The material according to claim 4 wherein the dendrisilica is made from dendrimer [(EtO)₃Si(C₂H₄)]₃SiCH₂Si[C₂H₄)Si(OEt)₃]₃ (4).

10. The material according to claim 1 wherein the polydendrimer is made of a single type of dendrimer comprising a polymerizable group at the outmost shell of the dendrimer.

11. The material according to claim 1 wherein the polydendrimer is a mixture of two or more dendrimers, each dendrimer of the mixture comprising a polymerizable group at the outmost shell of the dendrimer.

12. The material according to claim 10 wherein the polymerizable group is a tri-alkoxysilyl group or trichloro-silyl group.

13. The material according to claim 10 wherein the polymerizable group is a vinyl group.

14. The material according to claim 1 formed as a powder.

15. The material according to claim 1 formed as a film.

16. The material according to claim 1 formed as a monolith.

17. The material according to claim 1 formed as a fiber.

18. A dendrimer tetrakis[2-(tris-(triethoxy, 2-ethylsilyl)silyl)ethyl]silane having a formula Si[(C₂H₄)Si((C₂H₄)Si(OEt)₃)₃]₄ (3).

19. A dendrimer bis-[tris-(2-(triethoxysilyl)ethyl)disila]methane having a formula [(EtO)₃Si(C₂H₄)]₃SiCH₂Si[(C₂H₄)Si(OEt)₃]₃ (4).

20. A method of synthesizing a periodic porous polydendrimer with uniform pores of tunable size, comprising:
mixing a dendrimer with a template under conditions suitable for self-assembly of the dendrimer to form a polydendrimer encapsulating the template; and
removing the template from the polydendrimer to give the periodic porous polydendrimer with uniform pores of tunable size.

21. The method according to claim 20 wherein the template is chosen to give a periodic mesoporous polydendrimer.

22. The method according to claim 21 wherein the dendrimer is chosen to give a polydendrimer which is a periodic mesoporous dendrisilica.

23. The method according to claim 20 wherein the template is chosen to give a periodic macroporous polydendrimer.

24. The method according to claim 23 wherein the dendrimer is chosen to give a polydendrimer which is a periodic macroporous dendrisilica.

25. The method according to claim 22 wherein the dendrimer is Si[(C₂H₄)Si(OEt)₃]₄ (1).

26. The method according to claim 22 wherein the dendrimer is Si[(C₂H₄)Si(Oi-Pr)₃]₄ (i-Pr=isopropoxy) (2).

27. The method according to claim 22 wherein the dendrimer is Si[(C₂H₄)Si((C₂H₄)Si(OEt)₃)₃]₄ (3).

28. The method according to claim 22 wherein the dendrimer is [(EtO)₃Si(C₂H₄)]₃SiCH₂Si[(C₂H₄)Si(OEt)₃]₃ (4).

29. The method according to claim 20 wherein the template is a non-ionic surfactant.

30. The method according to claim 20 wherein the template is an ionic surfactant.

31. The method according to claim 20 wherein the template is a colloidal crystal template.

32. (canceled)

33. The method according to claim 20 wherein the polydendrimer is made by polymerization of a dendrimer comprising a polymerizable group at the outmost shell of the dendrimer, and wherein the polydendrimer self-assembles prior to polymerization of the polymerizable group.

34. The method according to claim 20 wherein the polydendrimer is made by polymerization of a mixture of two or more types of dendrimers, each dendrimer of the mixture of two or more dendrimers comprising a polymerizable group at the outmost shell of each dendrimer.

35. The method according to claim 33 wherein the polymerizable group is a tri-alkoxysilyl group or trichloro-silyl group.

36. The method according to claim 33 wherein the polymerizable group is a vinyl group.

37. The method according to claim 20 formed as a powder.

38. The method according to claim 20 wherein the periodic porous polydendrimer is formed as a film.

39. The method according to claim 20 wherein the periodic porous polydendrimer is formed as a monolith.

40. The method according to claim 20 wherein the periodic porous polydendrimer is formed as a fiber.

41. The method according to claim 20 wherein the step of removing the template includes heating to sufficient temperature to decompose the template, or solvent extraction, supercritical fluid extraction photolytic decomposition, or plasma etching of the template.

42. The method according to claim 20 including a post-synthesis step of attaching a reactive chemical group to the dendrimers of the polydendrimer.

43. The method according to claim 38 wherein the film is made by spin-coating, dip-coating or casting a solution containing the dendrimer and template on a substrate, after which the film on the substrate is dried and thereafter the template is removed.

44. The method according to claim 39 wherein the monolith is made using a sol-gel method, wherein the dendrimers are mixed with the template in an aqueous solution to give a homogeneous sol, inducing gelation of the sol in a reaction vessel of pre-selected shape to give a monolith of pre-selected shape, after which the template is extracted with organic or inorganic solvents.

45. The method according to claim 40 wherein the fiber is made by extruding or spinning a viscous sol containing the dendrimers, the template and the solvent to produce a polydendrimer/template nanocomposite fiber, after which the template is removed from the fibers by solvent extraction to leave a porous polydendrimer.

46. A method of producing a periodic macroporous polydendrimer, comprising the steps of:
infiltrating a dendrimer into void spaces of a colloidal crystal template comprising colloidal particles;
polymerizing the dendrimer to form a polydendrimer; and
removing the colloidal crystal template to give the periodic macroporous polydendrimer with uniform pores of tunable size.

47. The method according to claim 46 wherein the polydendrimer is made by polymerization of a dendrimer comprising a polymerizable group at the outmost shell of the dendrimer, and wherein the polydendrimer self-assembles prior to polymerization of the polymerizable group.

48. The method according to claim 46 wherein the polydendrimer is made by polymerization of a mixture of two or more types of dendrimers, each dendrimer of the mixture of two or more dendrimers comprising a polymerizable group at an outmost shell of each dendrimer.

49. (canceled)

50. The method according to claim 47 wherein the polymerizable group is a tri-alkoxysilyl group or trichloro-silyl group.

51. The method according to claim 47 wherein the polymerizable group is a vinyl group.

52. The method according to claim 46 wherein the dendrimer is Si[(C₂H₄)Si(OEt)₃]₄ (1).

53. The method according to claim 46 wherein the dendrimer is Si[(C₂H₄)Si(Oi-Pr)₃]₄ (2)(i-Pr=isopropoxy).

54. The method according to claim 46 wherein the dendrimer is Si[(C₂H₄)Si((C₂H₄)Si(OEt)₃)₃]₄ (3).

55. The method according to claim 46 wherein the dendrimer is [(EtO)₃Si(C₂H₄)]₃SiCH₂Si[(C₂H₄)Si(OEt)₃]₃ (4).

56. The method according to claim 46 wherein the step of removing the colloidal crystal template to give a macroporous polydendrimer includes heating to sufficient temperature to decompose the colloidal crystal template.

57. The method according to claim 46 wherein the step of removing the colloidal crystal template to give a macroporous polydendrimer includes solvent extraction, supercritical fluid extraction, photolytic decomposition, or plasma etching of the colloidal crystal template.

58. A periodic macroporous polydendrimer produced by the steps comprising:
infiltrating a dendrimer into void spaces in a colloidal crystal template comprised of colloidal particles;
polymerizing the dendrimer to produce a polydendrimer; and
removing the colloidal particles to give the periodic macroporous polydendrimer with uniform pores of tunable size.

59. (canceled)

60. The method according to claim 20 wherein the template is a combination of molecular, polymer or colloidal templates, to produce a porous polydendrimer having at least two different sizes of pores.

61. A method of synthesizing a periodic mesoporous macroporous polydendrimer comprising infiltrating a dendrimer and a mesoscale template into a macroscale colloidal template material under conditions suitable for polymerization of the dendrimer followed by removing both the mesoscale and macroscale template materials from the polydendrimer/template composite to give a periodic mesoporous macroporous polydendrimer (PMeMaP).

62. The material according to claim 5 wherein the dendrisilica is made from dendrimer Si[(C₂H₄)Si(OEt)₃]₄ (1).

63. The material according to claim 5 wherein the dendrisilica is made from dendrimer Si[(C₂H₄)Si(Oi-Pr)₃]₄ (i-Pr=isopropoxy) (2).

64. The material according to claim 5 wherein the dendrisilica is made from dendrimer Si[(C₂H₄)Si((C₂H₄)Si(OEt)₃)₃]₄ (3).

65. The material according to claim 5 wherein the dendrisilica is made from dendrimer [(EtO)₃Si(C₂H₄)]₃SiCH₂Si[(C₂H₄)Si(OEt)₃]₃ (4).

66. The method according to claim 24 wherein the dendrimer is Si[(C₂H₄)Si(OEt)₃]₄ (1).

67. The method according to claim 24 wherein the dendrimer is Si[(C₂H₄)Si(Oi-Pr)₃]₄ (i-Pr=isopropoxy) (2).

68. The method according to claim 24 wherein the dendrimer is Si[(C₂H₄)Si((C₂H₄)Si(OEt)₃)₃]₄ (3).

69. The method according to claim 24 wherein the dendrimer is [(EtO)₃Si(C₂H₄)]₃SiCH₂Si[(C₂H₄)Si(OEt)₃]₃ (4).

70. The material according to claim 11 wherein the polymerizable group is a tri-alkoxysilyl group or trichloro-silyl group.

71. The material according to claim 11 wherein the polymerizable group is a vinyl group.

72. The method according to claim 34 wherein the polymerizable group is a tri-alkoxysilyl group or trichloro-silyl group.

73. The method according to claim 34 wherein the polymerizable group is a vinyl group.

74. The method according to claim 48 wherein the polymerizable group is a tri-alkoxysilyl group or trichloro-silyl group.

75. The method according to claim 48 wherein the polymerizable group is a vinyl group.
